(19) United States
(12) Patent Application Publication
(10) Pub. No.: US 2022/0371598 A1
(43) Pub. Date: Nov. 24, 2022

(54) VEHICLE POWER SUPPLY SYSTEM, VEHICLE POWER SUPPLY APPARATUS, AND VEHICLE POWER SUPPLY PROGRAM

(71) Applicant: TOYOTA JIDOSHA KABUSHIKI KAISHA, Toyota-shi (JP)

(72) Inventors: Masaki ITO, Toyota-shi (JP); Yuki TAKAHASHI, Susono-shi (JP); Yuko KIMURA, Tagata-gun (JP); Masatoshi HAYASHI, Nisshin-shi (JP); Hideki NAKAZONO, Susono-shi (JP); Tomohiro KANEKO, Mishima-shi (JP)

(73) Assignee: TOYOTA JIDOSHA KABUSHIKI KAISHA, Toyota-shi (JP)

(21) Appl. No.: 17/659,877

(22) Filed: Apr. 20, 2022

(30) Foreign Application Priority Data
May 18, 2021 (JP) 2021-084212

(51) Int. Cl. B60W 40/06; G08G 1/00; G08G 1/01

(52) U.S. Cl. CPC B60W 40/06; G08G 1/202; G08G 1/0133; G08G 1/0141; B60W 2552/35

(57) ABSTRACT

A vehicle power supply system includes a vehicle power supply apparatus including a processor. When a disaster by which foreign matter might be deposited on a road occurs, the processor preferentially performs power supply to a road maintenance vehicle configured to perform maintenance on the road.

### CROSS-REFERENCE TO RELATED APPLICATION

This application claims priority to Japanese Patent Application No. 2021-084212 filed on May 18, 2021, incorporated herein by reference in its entirety.

### BACKGROUND

### 1. Technical Field

This disclosure relates to a vehicle power supply system, a vehicle power supply apparatus, and a vehicle power supply program.

### 2. Description of Related Art

Japanese Unexamined Patent Application Publication No. 2019-008339 (JP 2019-008339 A) describes a technology that allows an EV vehicle such as an emergency vehicle to preferentially use an EV charging facility at the time of occurrence of a disaster.

### SUMMARY

A technology that can remove foreign matter on a road at an early stage when the foreign matter is disposed on the road due to volcanic disaster, flood, or the like has been demanded.

This disclosure is accomplished in view of the above problems, and an object of this disclosure is to provide a vehicle power supply system, a vehicle power supply apparatus, and a vehicle power supply program that can remove foreign matter on a road at an early stage when the foreign matter is deposited on the road due to volcanic disaster, flood, or the like.

A vehicle power supply system according to this disclosure includes a vehicle power supply apparatus including a processor. When a disaster by which foreign matter is deposited on a road occurs, the processor preferentially performs power supply to a road maintenance vehicle configured to perform maintenance on the road.

A vehicle power supply apparatus according to this disclosure includes a processor. When a disaster by which foreign matter is deposited on a road occurs, the processor preferentially performs power supply to a road maintenance vehicle configured to perform maintenance on the road.

A vehicle power supply program according to this disclosure causes a processor to, when a disaster by which foreign matter is deposited on a road occurs, preferentially perform power supply to a road maintenance vehicle configured to perform maintenance on the road.

With this disclosure, when foreign matter is deposited on a road due to volcanic disaster, flood, or the like, the foreign matter on the road can be removed at an early stage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an overall configuration of a vehicle power supply system according to an embodiment;

FIG. 2 is a block diagram illustrating details of each constituent of the vehicle power supply system according to the embodiment; and

FIG. 3 is a flowchart illustrating an example of the procedure of a vehicle power supply method to be executed by the vehicle power supply system according to the embodiment.

### DETAILED DESCRIPTION OF EMBODIMENTS

A vehicle power supply system, a vehicle power supply apparatus, and a vehicle power supply program according to an embodiment of this disclosure will be described with reference to the drawings. Note that constituents in the following embodiment include a constituent easily replaceable by a person skilled in the art or substantially the same constituents.

Vehicle Power Supply System

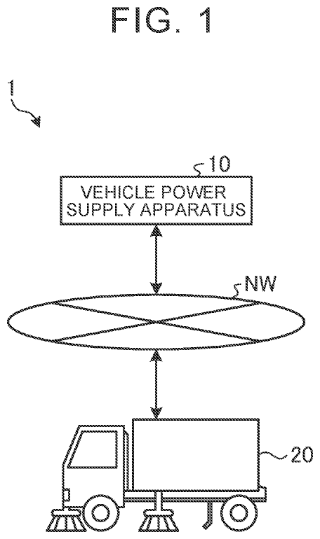

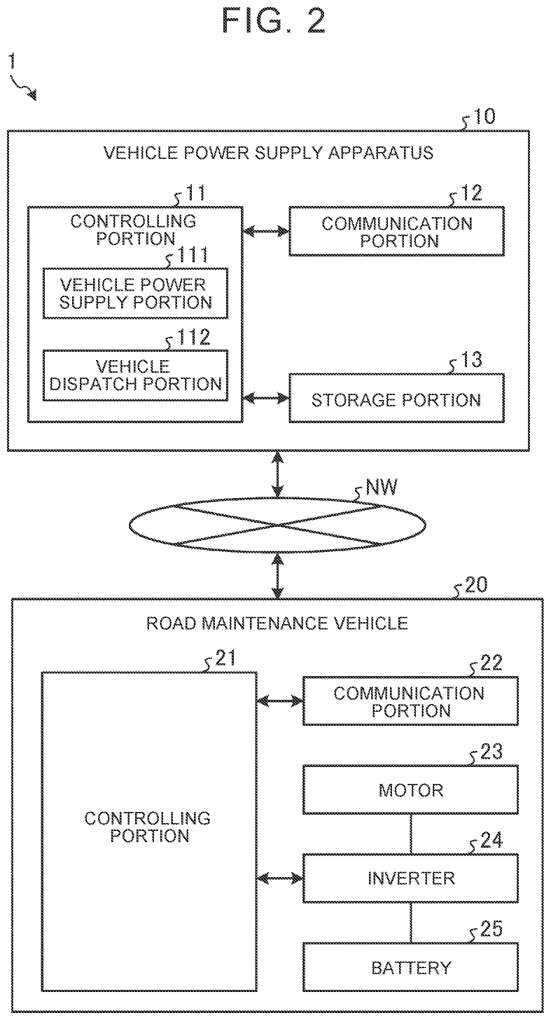

The vehicle power supply system including the vehicle power supply apparatus according to the embodiment will be described with reference to FIGS. 1, 2. As illustrated in FIG. 1, a vehicle power supply system 1 includes a vehicle power supply apparatus 10 and a road maintenance vehicle 20. Note that FIG. 1 deals with an example in which one road maintenance vehicle 20 is used, but a plurality of road maintenance vehicles 20 may be used.

The vehicle power supply apparatus 10 and the road maintenance vehicle 20 include respective communication functions and are configured to be communicable with each other via a network NW. The network NW is constituted by an Internet line network, a mobile phone network, or the like, for example.

Vehicle Power Supply Apparatus

The vehicle power supply apparatus 10 is configured to perform power supply to electrified vehicles (EV vehicles, plug-in hybrid electric vehicles) including the road maintenance vehicle 20. The vehicle power supply apparatus 10 is implemented by a general-purpose computer such as a workstation or a personal computer, for example. Further, the vehicle power supply apparatus 10 is provided, for example, in a power supply station for electrified vehicles, a management center, an automobile dealer, or the like that can supply electric power to electrified vehicles including the road maintenance vehicle 20.

As illustrated in FIG. 2, the vehicle power supply apparatus 10 includes a controlling portion 11, a communication portion 12, and a storage portion 13. More specifically, the controlling portion 11 includes: a processor constituted by a central processing unit (CPU), a digital signal processor (DSP), a field-programmable gate array (FPGA), a graphics processing unit (GPU), or the like; and a memory (a main storage portion) such as a random access memory (RAM) or a read only memory (ROM).

The controlling portion 11 loads a program stored in the storage portion 13 into a working area of the main storage portion and executes the program, so that each constituent part or the like is controlled through the execution of the program. Hereby, the controlling portion 11 implements a function corresponding to a predetermined purpose.

The controlling portion 11 functions as a vehicle power supply portion 111 and a vehicle dispatch portion 112 through the execution of programs stored in the storage portion 13.

The vehicle power supply portion 111 performs power supply to an electrified vehicle based on a power supply request from the electrified vehicle, for example. When a disaster (hereinafter referred to as a “specific disaster”) by which foreign matter might be deposited on a road occurs, the vehicle power supply portion 111 performs power supply to the road maintenance vehicle 20 configured to perform maintenance on the road (e.g., to clean up the road), in preference to power supply to other electrified vehicles. Examples of the “specific disaster” include, for example, volcanic disaster, flood (heavy rain), earth-flow disaster, heavy snowfall, typhoon, and so on. Further, information on whether the specific disaster occurs or not, information on an occurrence point, or the like can be acquired from a server or the like of an organization or a company that provides disaster information, for example. As such, at the time when the specific disaster occurs, power supply to the road maintenance vehicle 20 is performed preferentially, so that the road maintenance vehicle 20 can be activated at an early stage and can perform maintenance on the road at an early stage.

The vehicle dispatch portion 112 dispatches the road maintenance vehicle 20 that has received power supply from the vehicle power supply portion 111 to a road that requires maintenance. At the time of the occurrence of the specific disaster, for example, the vehicle dispatch portion 112 specifies a road with a high necessity of maintenance and dispatches the road maintenance vehicle 20 to the road thus specified.

In this case, the vehicle dispatch portion 112 specifies a road where the traffic volume of vehicles is reduced in comparison with a reference set in advance. Subsequently, the vehicle dispatch portion 112 transmits (outputs) information on the position of the road where the traffic volume is reduced to the road maintenance vehicle 20 via the network NW, so that the vehicle dispatch portion 112 dispatches the road maintenance vehicle 20 to the road. Note that an acquisition method of acquiring the traffic volume of vehicles is not limited in particular. The traffic volume may be acquired from a server or the like of an organization or a company that provides road traffic information, or a video image may be acquired from a camera provided in the road and analyzed, for example. When the road maintenance vehicle 20 is dispatched by estimating a road with a reduced traffic volume as a road that requires maintenance as such, it is possible to perform maintenance on the road at an early stage. Further, by use of information on the traffic volume of vehicles, a road that requires maintenance can be specified without checking video images or the like of the road, for example.

Further, the vehicle dispatch portion 112 may dispatch, to a road that requires maintenance, the road maintenance vehicle 20 that can perform maintenance on the road. Here, to “dispatch the road maintenance vehicle 20 that can perform maintenance on the road” means that a road sweeper is dispatched to a road on which dirt is deposited, a high-pressure washing vehicle is dispatched to a road on which volcanic ashes are deposited, or a sludge suction vehicle is dispatched to a road on which sludge is deposited, for example.

In this case, the vehicle dispatch portion 112 specifies a road where the traffic volume of vehicles is reduced in comparison with a reference set in advance. Subsequently, the vehicle dispatch portion 112 specifies a state of the road surface of the road where the traffic volume is reduced. Note that an acquisition method of acquiring the state of the road surface of the road is not limited in particular, and the state of the road surface may be acquired from a server or the like of an organization or a company that provides road traffic information or the like, or a video image may be acquired from a camera provided in the road and analyzed, for example.

Subsequently, the vehicle dispatch portion 112 transmits, via the network NW, information on the position of the road where the traffic volume is reduced to the road maintenance vehicle 20 that can perform maintenance on the road, so that the vehicle dispatch portion 112 dispatches the road maintenance vehicle 20 to the road. By dispatching the road maintenance vehicle 20 suitable for the state of the road surface as such, maintenance can be appropriately performed on the road at an early stage.

Further, the vehicle dispatch portion 112 may dispatch, to a road that requires maintenance, as many road maintenance vehicles 20 as needed for maintenance. In this case, the vehicle dispatch portion 112 specifies a road where the traffic volume of vehicles is reduced in comparison with a reference set in advance. Subsequently, the vehicle dispatch portion 112 specifies the deposition amount of foreign matter deposited on the road surface of the road where the traffic volume is reduced. Note that the deposition amount of the foreign matter on the road surface of the road can be estimated, for example, based on the traffic volume of vehicles on the road. That is, a road with a small traffic volume of vehicles can be estimated as a road with a large deposition amount of the foreign matter. Conversely, a road with a large traffic volume of vehicles can be estimated as a road with a small deposition amount of the foreign matter. Further, the deposition amount of the foreign matter on the road surface of the road may be acquired from a server or the like of an organization or a company that provides road traffic information or the like, or a video image may be acquired from a camera provided in the road and analyzed, for example.

Subsequently, the vehicle dispatch portion 112 determines the number of road maintenance vehicles 20 to be dispatched to the road based on the specified deposition amount of the foreign matter. In this case, the vehicle dispatch portion 112 determines the number of road maintenance vehicles 20 such that the number of road maintenance vehicles 20 is larger as the deposition amount of the foreign matter is larger, and the number of road maintenance vehicles 20 is smaller as the deposition amount of the foreign matter is smaller. Further, the vehicle dispatch portion 112 may set the number of road maintenance vehicles 20 for each deposition amount of the foreign matter in advance, and the vehicle dispatch portion 112 may determine the number of road maintenance vehicles 20 so as to correspond to the deposition amount of the foreign matter.

Subsequently, the vehicle dispatch portion 112 transmits, via the network NW, information on the position of the road where the traffic volume is reduced to each of the road maintenance vehicles 20 thus determined, so that the vehicle dispatch portion 112 dispatches the road maintenance vehicles 20 to the road. By dispatching as many road maintenance vehicles 20 as needed for maintenance as such, the maintenance can be appropriately performed on the road at an early stage.

The communication portion 12 is constituted by a local area network (LAN) interface board, a radio communications circuit for wireless communication, and so on, for example. The communication portion 12 is connected to the network NW such as the Internet that is a public communication network. The communication portion 12 is connected to the network NW so as to communicate with the road maintenance vehicles 20.

The storage portion 13 is constituted by a recording medium such as an erasable programmable ROM (EPROM), a hard disk drive (HDD), or a removable medium. Examples of the removable medium include a universal serial bus (USB) memory and disc recording media such as a compact disc (CD), a digital versatile disc (DVD), and a Blu-ray (registered trademark) disc (BD), for example.

In the storage portion 13, an operating system (OS), various programs, various tables, various databases, and the like can be stored. In the storage portion 13, information on the traffic volume of vehicles in each road, information on the state of the road surface of the road, the deposition amount of foreign matter on the road surface of the road, and so on that are acquired via the network NW are stored as necessary, for example.

Road Maintenance Vehicle

The road maintenance vehicle 20 is a vehicle configured to perform maintenance on a road at the time when a disaster by which foreign matter might be deposited on the road occurs. Examples of the road maintenance vehicle 20 include a road sweeper, a high-pressure washing vehicle, a road sprinkler, a compressed-air carried vehicle, a sludge suction vehicle, and so on.

The road maintenance vehicle 20 is constituted by an EV vehicle or a plug-in hybrid electric vehicle. The present embodiment deals with a case where the road maintenance vehicle 20 is an EV vehicle. Alternatively, the road maintenance vehicle 20 may be a self-driving vehicle movable autonomously without the operation by a driver.

As illustrated in FIG. 2, the road maintenance vehicle 20 includes a controlling portion 21, a communication portion 22, a motor 23, an inverter 24, and a battery 25. The controlling portion 21 is an electronic control unit including, as a main component, a microcomputer constituted by a CPU, a ROM, a RAM, and so on. The controlling portion 21 generally controls the operation of various components provided in the road maintenance vehicle 20 by executing various programs.

The communication portion 22 is constituted by a data communication module (DCM) or the like, for example, and communicates with the vehicle power supply apparatus 10 by wireless communication via the network NW. In the storage portion 13, information on the position of a road with a reduced traffic volume, and the like that is acquired from the vehicle power supply apparatus 10 is stored as needed, for example.

The motor 23 is a drive source for the road maintenance vehicle 20. The inverter 24 is configured to drive the motor 23. The battery 25 is charged with electric power to be used to drive the motor 23. The battery 25 is electrically connected to the motor 23 via the inverter 24.

Note that, in a case where the road maintenance vehicle 20 is a self-driving vehicle, the road maintenance vehicle 20 further includes a GPS information positioning portion and a sensor group including a camera, a 3D-LiDAR, a millimeter wave sensor, an infrared sensor, an acceleration sensor, a GPS sensor, and the like that are necessary to achieve self-driving, in addition to the constituents illustrated in FIG. 2.

Vehicle Power Supply Method

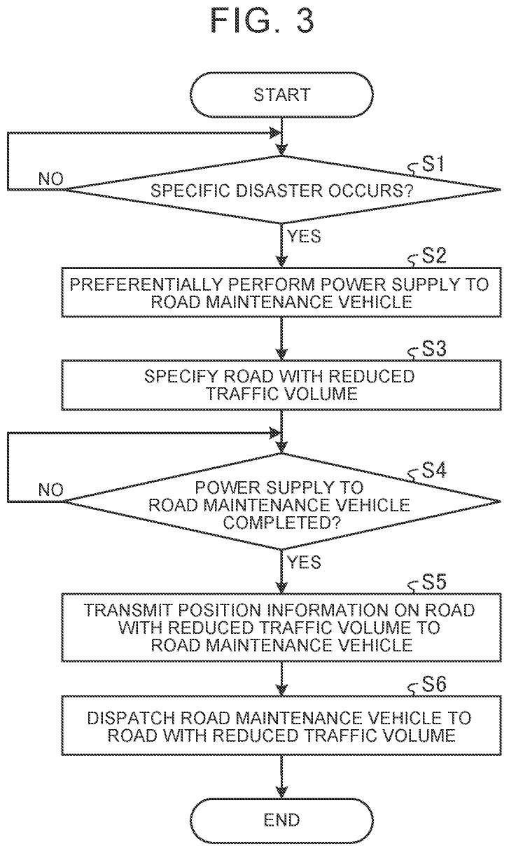

One example of the procedure of a vehicle power supply method to be executed by the vehicle power supply system 1 according to the embodiment will be described with reference to FIG. 3. FIG. 3 describes processes to be executed mainly by the vehicle power supply apparatus 10.

First, the vehicle power supply portion 111 determines whether a specific disaster occurs or not (step S1). In step S1, an affirmative determination is made in a case where information on the specific disaster is acquired from a server or the like of an organization or a company that provides disaster information, for example, and a negative determination is made in a case where the information on the specific disaster is not acquired.

In a case where the specific disaster is determined to occur in step S1 (Yes in step S1), the vehicle power supply portion 111 performs power supply to the road maintenance vehicle 20 in preference to power supply to other electrified vehicles (step S2). Note that, in a case where the specific disaster is determined not to occur in step S1 (No in step S1), the vehicle power supply portion 111 returns to the determination in step S1.

Subsequently, the vehicle dispatch portion 112 specifies a road where the traffic volume of vehicles is reduced in comparison with a reference set in advance (step S3). Subsequently, the vehicle dispatch portion 112 determines whether power supply to the road maintenance vehicle 20 is completed or not (step S4).

In a case where power supply to the road maintenance vehicle 20 is determined to be completed in step S4 (Yes in step S4), the vehicle dispatch portion 112 transmits information on the position of the road where the traffic volume is reduced to the road maintenance vehicle 20 (step S5). Thus, the road maintenance vehicle 20 is dispatched to the road where the traffic volume is reduced (step S6). Hereby, the process of the vehicle power supply method is completed.

Note that, in a case where power supply to the road maintenance vehicle 20 is determined not to be completed in step S4 (No in step S4), the vehicle dispatch portion 112 returns to the determination in step S4.

As described above, with the vehicle power supply system, the vehicle power supply apparatus, and the vehicle power supply program according to the embodiment, at the time when a specific disaster occurs, power supply to the road maintenance vehicle 20 configured to perform maintenance on a road is performed in preference to power supply to other electrified vehicles. Hereby, in a case where foreign matter is deposited on a road due to volcanic disaster, flood, or the like, for example, the foreign matter on the road can be removed by the road maintenance vehicle 20 at an early stage. Accordingly, at the time when the specific disaster occurs, the traffic of vehicles, wheelchairs, pedestrians, and so on can be secured at an early stage.

Further effects and modifications can be easily derived by a person skilled in the art. On this account, a mode wider than the present disclosure is not limited to the specific details and the representative embodiment represented and described as above. Accordingly, various changes can be made without departing from the spirit or scope of the concept of a general disclosure defined by the attached claims and their equivalents.

What is claimed is:

1. A vehicle power supply system comprising a vehicle power supply apparatus including a processor, wherein, when a disaster by which foreign matter is deposited on a road occurs, the processor preferentially performs power supply to a road maintenance vehicle configured to perform maintenance on the road.

2. The vehicle power supply system according to claim 1, wherein:
the processor specifies a road where a traffic volume of vehicles is reduced in comparison with a reference set in advance; and
the processor outputs, to the road maintenance vehicle, information on a position of the road where the traffic volume is reduced such that the road maintenance vehicle is dispatched to the road.

3. The vehicle power supply system according to claim 2, wherein:
the processor specifies a state of a road surface of the road where the traffic volume is reduced; and
the processor outputs the information on the position of the road where the traffic volume is reduced to the road maintenance vehicle configured to perform maintenance on the road such that the road maintenance vehicle is dispatched to the road.

4. The vehicle power supply system according to claim 2, wherein:
the processor specifies a deposition amount of foreign matter deposited on a road surface of the road where the traffic volume is reduced;
the processor determines the number of road maintenance vehicles to be dispatched to the road based on the deposition amount; and
the processor outputs, to the road maintenance vehicles thus determined, the information on the position of the road where the traffic volume is reduced such that the road maintenance vehicles are dispatched to the road.

5. A vehicle power supply apparatus comprising a processor, wherein, when a disaster by which foreign matter is deposited on a road occurs, the processor preferentially performs power supply to a road maintenance vehicle configured to perform maintenance on the road.

6. The vehicle power supply apparatus according to claim 5, wherein:
the processor specifies a road where a traffic volume of vehicles is reduced in comparison with a reference set in advance; and
the processor outputs, to the road maintenance vehicle, information on a position of the road where the traffic volume is reduced such that the road maintenance vehicle is dispatched to the road.

7. The vehicle power supply apparatus according to claim 6, wherein:
the processor specifies a state of a road surface of the road where the traffic volume is reduced; and
the processor outputs the information on the position of the road where the traffic volume is reduced to the road maintenance vehicle configured to perform maintenance on the road such that the road maintenance vehicle is dispatched to the road.

8. The vehicle power supply apparatus according to claim 6, wherein:
the processor specifies a deposition amount of foreign matter deposited on a road surface of the road where the traffic volume is reduced;
the processor determines the number of road maintenance vehicles to be dispatched to the road based on the deposition amount; and
the processor outputs, to the road maintenance vehicles thus determined, the information on the position of the road where the traffic volume is reduced such that the road maintenance vehicles are dispatched to the road.

9. A vehicle power supply program causing a processor to, when a disaster by which foreign matter is deposited on a road occurs, preferentially perform power supply to a road maintenance vehicle configured to perform maintenance on the road.

10. The vehicle power supply program according to claim 9 further causing the processor to specify a road where a traffic volume of vehicles is reduced in comparison with a reference set in advance and to output, to the road maintenance vehicle, information on a position of the road where the traffic volume is reduced such that the road maintenance vehicle is dispatched to the road.

11. The vehicle power supply program according to claim 10 further causing the processor to specify a state of a road surface of the road where the traffic volume is reduced and to output the information on the position of the road where the traffic volume is reduced to the road maintenance vehicle configured to perform maintenance on the road such that the road maintenance vehicle is dispatched to the road.

12. The vehicle power supply program according to claim 10 further causing the processor to specify a deposition amount of foreign matter deposited on a road surface of the road where the traffic volume is reduced, to determine the number of road maintenance vehicles to be dispatched to the road based on the deposition amount, and to output, to the road maintenance vehicles thus determined, the information on the position of the road where the traffic volume is reduced such that the road maintenance vehicles are dispatched to the road.
